(19) United States
(12) Patent Application Publication
(10) Pub. No.: US 2006/0225539 A1
(43) Pub. Date: Oct. 12, 2006

(54) Adjustable wrench with two movable jaws

(76) Inventor: Joe Chen, Taichung Hsien (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/342,466

(22) Filed: Jan. 30, 2006

Related U.S. Application Data
(63) Continuation-in-part of application No. 11/099,717, filed on Apr. 6, 2005.

(30) Foreign Application Priority Data
Nov. 9, 2005 (TW) 094139251

(51) Int. Cl. B25B 13/16

(52) U.S. Cl. 81/163; 81/155; 81/170

(57) ABSTRACT

An adjustable wrench includes two walls disposed on an upper portion of a handle body to define a guiding slot therebetween. A driving shaft is rotatably mounted in the guiding slot. Two movable jaws have coupling portions which are coupled respectively to two connecting ends of the driving shaft by force transmitting mechanisms such that a rotational force of the driving shaft about a rotating axis is transmitted to drive the coupling portions to move along the rotating axis toward or away from each other, and two jaw portions which extend outwardly of the guiding slot for gripping a torqued object. Two operating members are disposed to flank the connecting ends and are operable to rotate the driving shaft such that the distance between the jaw portions can be adjusted to permit quick gripping and releasing of the torqued object.

### CROSS-REFERENCE TO RELATED APPLICATION

This application is a continuation-in-part of U.S. patent application Ser. No. 11/099,717, filed by the applicant on Apr. 6, 2005, the entire disclosure of which is incorporated herein by reference.

### BACKGROUND OF THE INVENTION

1. Field of the Invention

This invention relates to an adjustable wrench, more particularly to an adjustable wrench with two movable jaws which can be moved toward or away from each other by rotating a driving shaft.

2. Description of the Related Art

An adjustable wrench is capable of conforming to the various sizes of torqued objects, such as screw nuts. Referring to FIG. 1, a conventional adjustable wrench 10 is shown to include a handle 11, a fixed jaw 12 integrally formed with an upper end of the handle 11, a movable jaw 17 which has a rack 16 received slidably in a guiding slot 13 in the handle 11, and a worm 15 which is rotatable so as to move the rack 16 along the guiding slot 13 to be close to or away from the fixed jaw 12.

However, the conventional adjustable wrench 10 suffers from the following drawbacks:

1. Since only the movable jaw 17 is moved during rotation of the worm 15 for adjusting a distance between the jaws 12,17, the adjusting operation is inefficient.

2. The conventional adjustable wrench 10 lacks means for retaining the rack 16 on the handle 11 when used to turn a torqued object, and is therefore susceptible to undesired movement. Besides, the torque that is produced when a force is applied to a torqued object in a turning operation is relatively small.

### SUMMARY OF THE INVENTION

An object of the present invention is to provide an adjustable wrench which can quickly grip or release a torqued object.

Another object of the present invention is to provide an adjustable wrench which has a retaining member for preventing rotation of an adjusting unit during a turning operation of a torqued object.

According to this invention, the adjustable wrench includes a handle body extending in a longitudinal direction and terminating at an upper portion. Amounting seat is mounted on the upper portion, and includes two walls which are spaced apart from each other in a first transverse direction relative to the longitudinal direction to define a guiding slot therebetween. The guiding slot extends in a second transverse direction relative to the first transverse direction and the longitudinal direction. Two movable jaws are disposed opposite to each other in the second transverse direction. Each of the movable jaws includes a coupling portion which is movably mounted in the guiding slot, and a jaw portion which extends from the coupling portion in the longitudinal direction and which extends outwardly of the guiding slot. A driving shaft is mounted in the guiding slot, is rotatable relative to the walls about a rotating axis in the second transverse direction, and has two connecting ends opposite to each other in the second transverse direction, and a middle portion interposed between the connecting ends. Each of two force transmitting mechanisms includes internally and externally threaded portions which are respectively disposed on a respective one of the coupling portions of the movable jaws and a respective one of the connecting ends of the driving shaft and which engage threadedly each other such that a rotational force of the driving shaft about the rotating axis is transmitted to drive the coupling portions to move in the second transverse direction toward or away from each other.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary exploded perspective view of a conventional adjustable wrench;

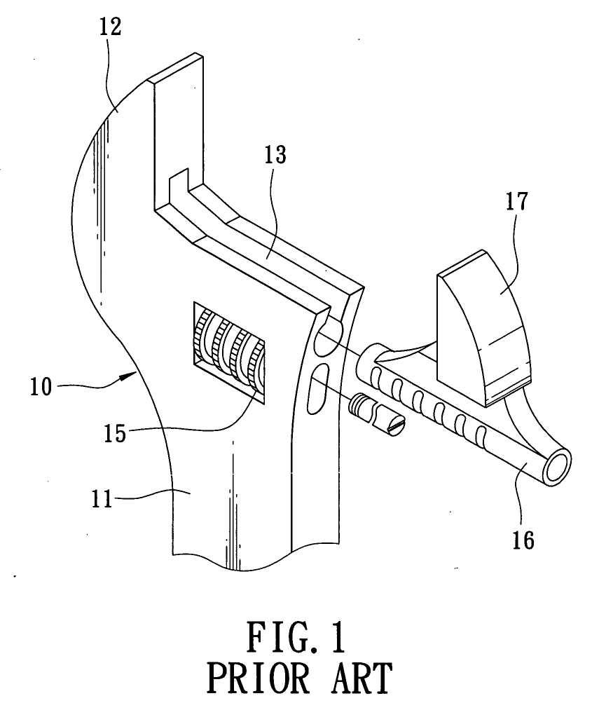

FIG. 2 is a schematic front view of the preferred embodiment of an adjustable wrench according to this invention;

FIG. 3 is a fragmentary perspective view showing an upper portion of a handle body of the preferred embodiment;

FIG. 4 is a partly sectioned, fragmentary exploded view of the preferred embodiment;

FIG. 5 is a fragmentary sectional view of the preferred embodiment when a retaining member is in a retaining position; and

FIG. 6 is a fragmentary schematic view of another preferred embodiment of an adjustable wrench according to this invention.

### DETAILED DESCRIPTION OF THE PREFERRED EMBODIMENT

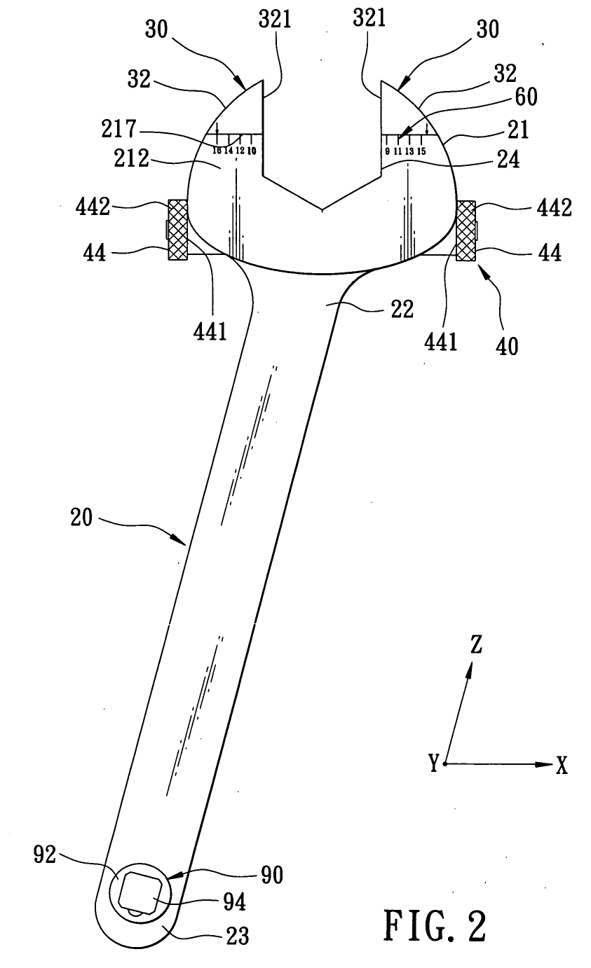

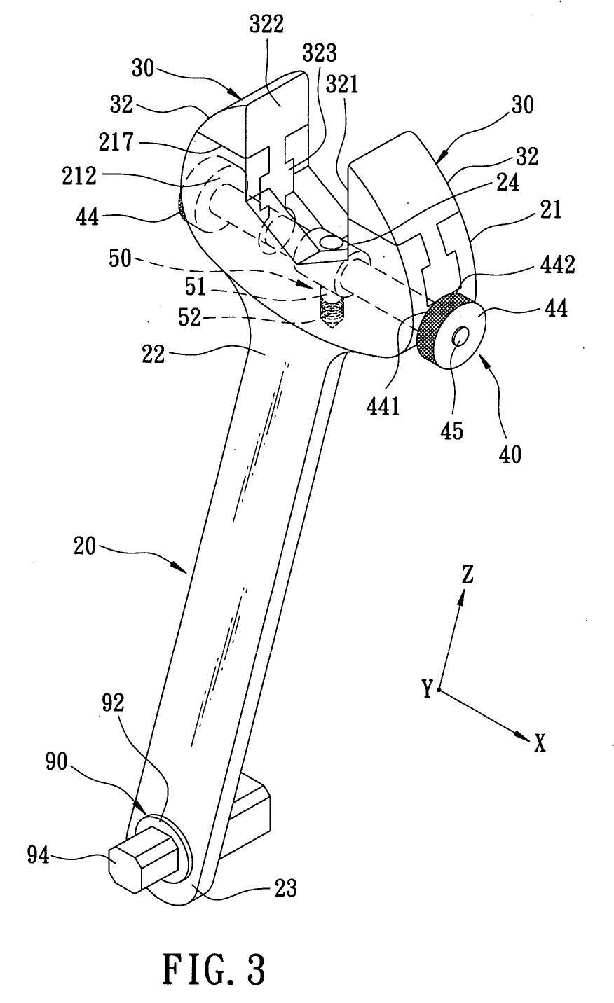

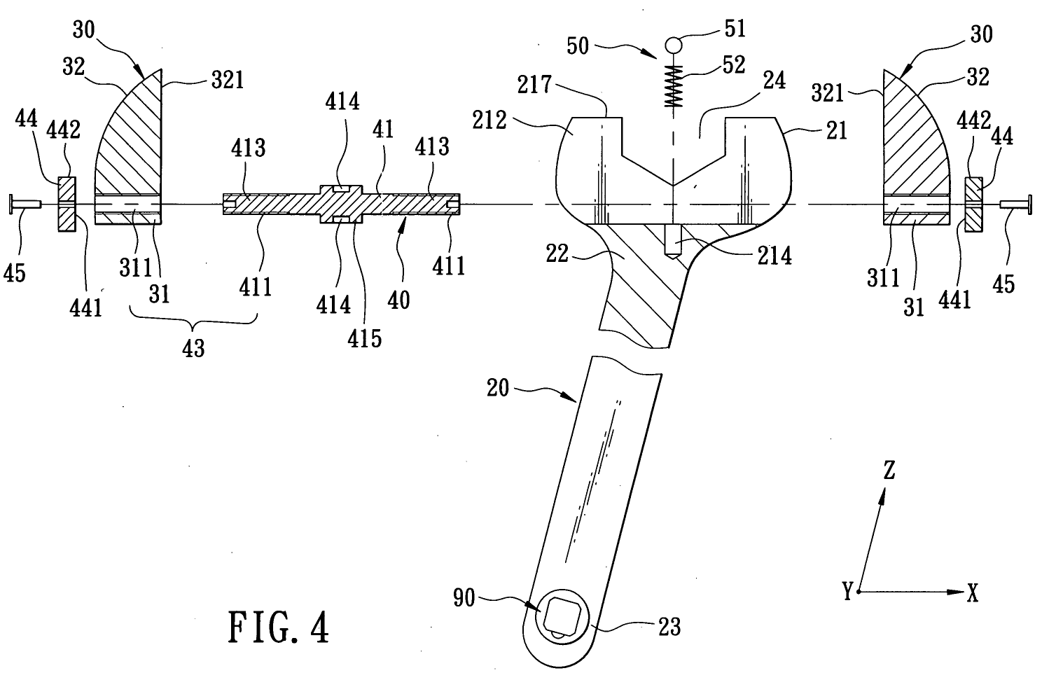

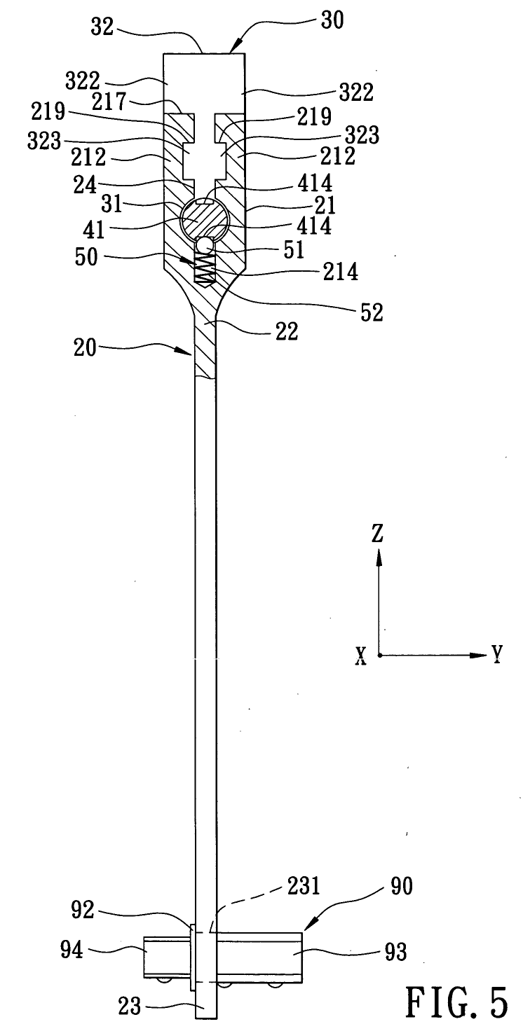

Referring to FIGS. 2 to 5, the preferred embodiment of an adjustable wrench according to the present invention is shown to comprise a handle body 20, two movable jaws 30, an adjusting unit 40, a retaining unit 50, and a scale 60.

The handle body 20 extends in a longitudinal direction (Z), and terminates at an upper portion 22. A mounting seat 21 is mounted on the upper portion 22, and includes two walls 212 which are spaced apart from each other in a first transverse direction (Y) relative to the longitudinal direction (Z) to define a guiding slot 24 therebetween. The guiding slot 24 extends in a second transverse direction (X) relative to the longitudinal direction (Z) and the first transverse direction (Y). The walls 212 of the mounting seat 21 respectively define two concavities 219 which are opposite to each other in the first transverse direction (Y), which extend in the second transverse direction (X), and which confront the guiding slot 24. Furthermore, each of the walls 212 has a top surface 217 extending in the second transverse direction (X).

The movable jaws 30 are disposed opposite to each other in the second transverse direction (X). Each of the jaws 30 includes a coupling portion 31 which is movably mounted in the guiding slot 24, and a jaw portion 32 which extends from the coupling portion 31 in the longitudinal direction (Z) and which extends outwardly of the guiding slot 24. Each of the jaws 30 has two engaging protrusions 322 which extend therefrom and which are disposed opposite to each other in the first transverse direction (Y) and which engage slidably the top surfaces 217 of the walls 212. Moreover, each of the jaws 30 has two reinforcing protrusions 323 which extend therefrom and which are disposed opposite to each other in the first transverse direction (Y) and which engage slidably the concavities 219.

The adjusting unit 40 includes a driving shaft 41, two force transmitting mechanisms 43, and two operating members 44. The driving shaft 41 is mounted in the guiding slot 24, is rotatable relative to the walls 212 about a rotating axis in the second transverse direction (X), and has two connecting ends 413 opposite to each other in the second transverse direction (X), and a middle portion 415 interposed between the connecting ends 413. Each of the force transmitting mechanisms 43 includes internally and externally threaded portions 311,411 which are in the form of a screw hole and a screw shank, respectively, which are respectively disposed on the coupling portion 31 of the respective jaw 30 and the respective connecting end 413 of the driving shaft 41, and which engage threadedly each other such that a rotational force of the driving shaft 41 about the rotating axis is transmitted to drive the coupling portions 31 of the jaws 30 to move in the second transverse direction (X) toward or away from each other. Thus, the distance between gripping surfaces 321 of the jaw portions 32 of the jaws 30 can be adjusted. The scale 60 is disposed on the wall 212 to indicate the distance between the gripping surfaces 321.

Each of the operating members 44 is secured to and is disposed to flank the respective connecting end 413 of the driving shaft 41 by means of a rivet 45, and has a rough outer surrounding surface 442 which surrounds the rotating axis and which is operable manually to rotate the driving shaft 41, and a guarding surface 441 which extends in the longitudinal direction (Z), and which confronts the respective coupling portion 31 so as to guard against excessive screw-out movement of the internally threaded portion 311 relative to the externally threaded portion 411, thereby preventing slippage of the jaws 30 from the connecting ends 413.

The retaining unit 50 includes a retaining member 51 and a biasing member 52. The mounting seat 21 has a recess 214 extending from the guiding slot 24 in a radial direction relative to the rotating axis. The middle portion 415 of the driving shaft 41 has two retaining holes 414 which are disposed diametrically opposite to each other relative to the rotating axis. The retaining member 51 is a pin ball, and is disposed in the recess 214 to be movable relative to the mounting seat 21 in the radial direction between a retaining position where the retaining member 51 engages a selected one of the retaining holes 414 to prevent rotation of the driving shaft 41, and a releasing position where the retaining member 51 disengages from the selected one of the retaining holes 414 to permit rotation of the driving shaft 41. The biasing member 52 is a coil spring which is disposed to bias the retaining member 51 to the retaining position.

Thus, in adjusting the distance between the gripping surfaces 321 of the jaws 30, as shown in FIG. 2, one of the operating members 44 is rotated against the biasing action of the biasing member 52 to move the retaining members 51 to the releasing position, and to rotate the driving shaft 41 so as to move the jaws 30 toward or away from each other for gripping a torqued object 80 of various dimensions.

It is noted that the externally threaded portions 411 of the force transmitting mechanisms 43 may be configured such that when the driving shaft 41 and the operating members 44 are rotated about 180 degrees, the jaws 30 can move relatively a distance of 1 inch, thereby permitting precise adjustment of the jaws 30 for conforming to the size of the torqued object 80.

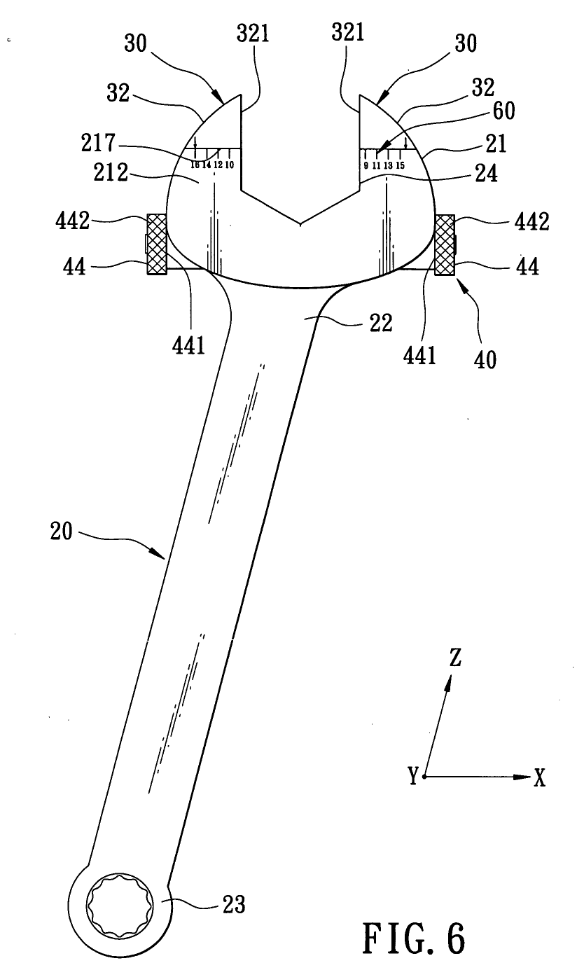

Furthermore, the handle body 20 has a lower portion 23 which is opposite to the upper portion 22 in the longitudinal direction (Z), and which has an insert hole 231 extending therethrough in the first transverse direction (Y). An insert member 90 has two insert ends 93,94 with two rectangular cross-sections of different sizes, and a flange 92 interposed therebetween such that the flange 92 abuts against the lower portion 23 when the insert member 90 is extended through the insert hole 231. Alternatively, referring to FIG. 6, the lower portion 23 may be a box end.

As illustrated, according to this invention, since rotation of the operating members 44 and the driving shaft 41 can move the jaws 30 synchronously in the second transverse direction (X), the jaws 30 can be operated to quickly grip or release a torqued object. Thus, the adjusting operation is efficient. Moreover, by virtue of the retaining member 51 which is biased by the biasing member 52 to engage a selected one of the retaining holes 414 so as to prevent rotation of the driving shaft 41, inadvertent movement of the jaws 30 during use of the adjustable wrench can be avoided. Besides, by virtue of the engagement between the engaging protrusions 322 and the top surfaces 217, and due to the engagement between the reinforcing protrusions 323 and the concavities 219, the torque that is produced when a force is applied to a torqued object in a turning operation can be increased.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. An adjustable wrench comprising:
a handle body extending in a longitudinal direction and terminating at an upper portion;
a mounting seat mounted on said upper portion, and including two walls which are spaced apart from each other in a first transverse direction relative to the longitudinal direction to define a guiding slot therebetween, said guiding slot extending in a second transverse direction relative to the first transverse direction and the longitudinal direction;
two movable jaws disposed opposite to each other in the second transverse direction, each of said movable jaws including a coupling portion which is movably mounted in said guiding slot, and a jaw portion which extends from said coupling portion in the longitudinal direction and which extends outwardly of said guiding slot;
a driving shaft which is mounted in said guiding slot and which is rotatable relative to said walls about a rotating axis in the second transverse direction, and which has two connecting ends opposite to each other in the second transverse direction, and a middle portion interposed between said connecting ends; and
two force transmitting mechanisms, each of which includes internally and externally threaded portions that are respectively disposed on a respective one of said coupling portions and a respective one of said connecting ends and that engage threadedly each other such that a rotational force of said driving shaft about the rotating axis is transmitted to drive said coupling portions to move in the second transverse direction toward or away from each other.

2. The adjustable wrench of claim 1, further comprising two operating members, each of which is secured to and which is disposed to flank a respective one of said connecting ends, each of said operating members having an outer surrounding surface which surrounds the rotating axis and which is operable manually to rotate said driving shaft.

3. The adjustable wrench of claim 2, wherein each of said operating members has a guarding surface which extends in the longitudinal direction, and which confronts the respective one of said coupling portions so as to guard against excessive screw-out movement of said internally threaded portion relative to said externally threaded portion.

4. The adjustable wrench of claim 1, wherein said mounting seat has a recess extending from said guiding slot in a radial direction relative to the rotating axis, said adjustable wrench further comprising a retaining member which is disposed in said recess to be movable relative to said mounting seat in the radial direction between a retaining position where said retaining member engages said driving shaft to prevent rotation of said driving shaft, and a releasing position where said retaining member disengages from said driving shaft to permit rotation of said driving shaft; and
a biasing member disposed to bias said retaining member to the retaining position.

5. The adjustable wrench of claim 4, wherein said middle portion of said driving shaft has a plurality of retaining holes which are angularly displaced from each other about the rotating axis, and which are configured such that said retaining member is slidably retained in a selected one of said retaining holes in the retaining position.

6. The adjustable wrench of claim 5, wherein said retaining holes are disposed diametrically opposite to each other relative to the rotating axis, said retaining member being a pin ball.

7. The adjustable wrench of claim 1, wherein each of said walls of said mounting seat has a top surface extending in the second transverse direction, each of said jaws having two engaging protrusions which extend therefrom and which are disposed opposite to each other in the first transverse direction and which engage slidably said top surfaces of said walls.

8. The adjustable wrench of claim 1, wherein said walls of said mounting seat respectively define two concavities which are opposite to each other in the first transverse direction, which extend in the second transverse direction, and which confront said guiding slot, each of said jaws having two reinforcing protrusions which extend therefrom and which are disposed opposite to each other in the first transverse direction and which engage slidably said concavities in said mounting seat.

9. The adjustable wrench of claim 1, wherein said handle body has a lower portion which is opposite to said upper portion in the longitudinal direction, and which has a box end.

10. The adjustable wrench of claim 1, wherein said handle body has a lower portion which is opposite to said upper portion in the longitudinal direction, and which has an insert hole extending therethrough in the first transverse direction, said wrench further comprising an insert member which has two insert ends of different dimensions, and a flange interposed therebetween such that said flange abuts against said lower portion when said insert member is extended through said insert hole.
